(19) United States
(12) Patent Application Publication
(10) Pub. No.: US 2015/0262317 A1
(43) Pub. Date: Sep. 17, 2015

(54) METHOD AND APPARATUS FOR TEMPORAL-BASED SHOWS FOR REAL ESTATE PROPERTIES

(71) Applicant: John Patrick Dempsey, Camarillo, CA (US)

(72) Inventor: John Patrick Dempsey, Camarillo, CA (US)

(21) Appl. No.: 14/206,240

(22) Filed: Mar. 12, 2014

(51) Int. Cl. G06Q 50/16; G06F 17/30

(52) U.S. Cl. CPC G06Q 50/16; G06F 17/30876; G06F 17/30241

(57) ABSTRACT

A method and a system to provide buyers, renters, agents, brokers, and all other users the ability to view temporal-based real estate shows for evaluating residential and commercial properties using the Internet.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

A method and a system to provide buyers, renters, agents, brokers, and all other users the ability to view temporal-based real estate shows for evaluating residential and commercial properties using the Internet.

Attempts to market and evaluate real estate properties includes flyers containing text and/or photos; real estate advertising in newspapers and magazines; real estate websites on a national, local office, and agent level; slide shows of property; virtual media tours where motion is simulated by moving in or out of a still photo while transitioning among a set of photos; Multiple Listing Services (MLSs); 360 degree panoramas of a property found on websites, some defined with “hotspots”; Digital Video Disc (DVD) produced material to promote a property; on-site open house visits; U.S. Pat. Appl. 20060020522 to Pratt (2006) designed to support real-time broadcast of an open house visit; TV broadcasts, such as HGTV channel; AM radio frequency narrative broadcast describing property at the property location; property information texted to a cellular device; video tours of properties, e.g., YouTube™ videos; and U.S. patent application Ser. No. 12/455,891 to Dempsey (2009) Interactive Open House Video Tours.

Other attempts to market and evaluate real estate properties are found on major real estate websites where the buyer can specify a property search, usually by entering the city, state combination or zip code the buyer is interested in. The buyer is then presented with different types of properties, such as properties for sale, for rent, pre-market properties, and foreclosures. The three most common user interfaces to display returned data are:
1. A hybrid satellite map showing a satellite image with physical streets overlaid on the satellite imagery showing street names, points of interest, and selected real estate properties. Icons are placed on the hybrid map to show the location of a property. Color coded icons typically depict whether the property is for sale, recently sold, for rent, pre-market, or a foreclosure.
2. A city street map showing the street names, points of interest, and selected real estate properties, but without the satellite image displayed. Color coded icons are used to show the location of a property and depict whether the property is for sale, recently sold, for rent, pre-market, or a foreclosure.
3. A list of properties, commonly in a table format, can be sorted by price, e.g., from high to low, in random order, or grouped by property type.

In addition, websites can search for properties based on Days on Market, Days on Website, New Listings in Past 7 Days, or ordered lists based on how new listings are to website.

Results from current websites are based on performing a search, returning a list of properties that meet the search criteria, and then having users “drill down” to view the property details. The returned properties are not incorporated into a multimedia presentation. In fact, there is no concept to incorporate the returned properties into a show.

In Sidhu (U.S. Pat. No. 8,463,775 B2), searches performed on a search engine website use temporal information to return results that are more likely to meet the user's need. The user can specify what to search for and a time frame. The time frame value specifies how far back previous searches done by the user and saved on the website can be used to help determine what the user is searching for. Using a slider on the search engine website, the user can specify the past month, the past week, the past day, the past hour, or times midway between these values. By saving and associating what the user has searched for in the past, search results more relevant to the user's interests can be customized for the user.

In Sudhu's approach, the user specifies a time component (or a default time component is used), but this time frame is specified by the user and is not associated with when the user last accessed the website. Also, the customized search results returned are similar in format to regular search engine results. While Sudhu's approach is temporal-based, it's hard to see how this approach could be used for real estate listings. The closest analogy would be to use the slider interface to specify the Days on the Market parameter. In Sudhu, there is no concept to incorporate the returned results into a show.

Multiple Listing Services (MLSs) and Sealand (U.S. Pat. No. 7,430,555 B2) allow agents to place buyers on an email list to keep buyers up-to-date on new or changed properties. Emails and text messages are sent at regular periodic time intervals and contain one or more property descriptions and photographs of newly added or changed properties found on an MLS.

However, while users are being kept up-to-date with new and changed listings using emails and text messages, the user must open, review, and close numerous emails. In a week, if there are 12 emails sent per day on average, this would force the user to open 84 emails. Emails are automatically sent in periodic time intervals rather than when the user returns to check for any updates.

Disadvantages of using emails and text messages are large number of emails and texts need to be opened, reviewed, and closed. They are not grouped or sorted (simply sent out), properties are not displayed as a group, for example on a map, and the properties are not incorporated into a multimedia presentation. There is no concept to incorporate the returned results into a show.

While not related to real estate properties, per se, some websites allow users to upload photos or contribute to a newsgroup or blog which can indicate if a photo was added to their library of photos or a new post was added to a newsgroup or blog since a user's last visit to their website. New photos are statically displayed as small thumbnail photos, and when selected, the photo is displayed in its full size. A newsgroup or blog with a new post can use color, text, or an icon to indicate that the newsgroup or blog has one or more new entries.

Disadvantages are that users still need to drill down to open, review, and close large number of posts. The new posts and photos are not grouped or summarized and are sorted by date added. The new posts and photos are not incorporated into a multimedia presentation. There is no concept to incorporate the returned results into a show.

### SUMMARY OF THE INVENTION

A method and apparatus to provide buyers, renters, agents, brokers, and all other users the ability to view temporal-based real estate shows for evaluating residential and commercial properties based on the user's date and time of last visit to website.

In this invention, associating an added date and time to real estate properties when said real estate properties are initially known to said website is a known attribute for a given said real estate property.

The added date and time is when a new property is added to the website using:

1. the website's own user interface to add a new property or

2. when the website first learns about a new listing from an external source.

Typically a website will read an external Rich Site Summary (RSS) feed for real estate listings. One of the readable attributes in an RSS feed is when the property was added to the feed.

In this invention, associating a last updated date and time to said real estate properties when said real estate properties were last updated to said website is a known attribute for a given said real estate property.

The last updated date and time is when a previously known property by website is changed in any way. Examples include, but are not limited to:

1. The original asking price is lowered (or increased).

2. The attributes describing the property are changed.

3. The property description is updated or replaced.

4. Additional photos and/or videos are added to real estate listing.

Typically the website will read an external RSS feed for real estate listings and the feed contains a readable attribute as to when a specific property was last updated.

In addition, real estate websites can obtain real estate listings from other external sources, such as using robots, spiders, and any other means, to collect real estate listings found on numerous Internet websites. Regardless of whether a real estate listing is added or updated on the website itself or is detected by other means, such as RSS feeds and robots, the website can identify when a listing has been added or updated.

In this invention, identifying said real estate properties whose said added date and time and said last updated date and time are more recent than or equal to last visit date and time of said user to said website can be performed by said website.

The last visit date and time is defined as the date and time when a user previously visited a website. Websites can read cookies stored on the user's device or can read a previously set database value set when a user logs into the website to determine the user's last visit date and time. A user device can be a computer, smart phone, tablet, or any other device which can store a cookie. Cookies are tiny text files which can contain up to 4000 characters of data. Websites can read and write cookies. The advantage of using cookies is the user doesn't need to log into the website to determine the last visit date and time. But the disadvantage is cookies can be deleted on the user's system usually when a user cleans their system. If the cookie is deleted, then the last visit date and time is not known and all properties would be displayed. The advantage of having users log into a website to determine the last visit date and time is the website's database can store this information and it won't be deleted when a user cleans their system. The disadvantage of this approach is the user must log into the website.

For properties stored on a website, the website's software can use Structured Query Language (SQL) queries to select from its own database which properties have been added or updated since the last visit date and time when the user last visited the website.

For properties listed in RSS feeds, the website's software can read the RSS feed attributes for a property and select which properties have been added or updated since the last visit date and time when the user last visited the website.

For other external sources of property listings, such as robots, spiders, or by any other means, the website's software can select which properties have been added or updated since the last visit date and time when the user last visited the website.

In this invention, generating a temporal-based show containing only said identified said real estate properties can be performed by said website.

A temporal-based show can incorporate and combine any and all types of media. Examples include real estate property slides, text, photographs, videos, interactive open house video tours along a default path, city street maps, hybrid satellite maps, third party software, sound, music, narration, and any other supported media types. The website can generate not only the show, but also generate media within the show itself. For example, an overview slide for each identified property can be generated and added to the show.

When identifying properties, additional criteria can be specified to better customize a show for a user. For example, users can select only properties found in one or more cities with a price range of $450,000 to $550,000, with four bedrooms and two bathrooms, in addition to selecting properties based on the user's last visit date and time.

In this invention, presenting said temporal-based show to said user can be performed by said website.

A novel feature of this invention is that a show can be viewed similar to a television program but whose content is determined by the real estate properties identified as being newly added properties or updated properties when compared to the last time the user visited the website. As such, the show is considered to be temporal, defined as being based on or relating to time. In one scenario, users can come home from work, watch a show, and pick up where the user previously left off, even if the last time they watched the show was an hour, day, week, or month ago. The show starts at the last visit date and time to the website by the user. A user can watch one or more shows to keep up-to-date with new listings or properties which have changed in one or more cities.

Using this approach, potential buyers and agents are no longer burdened by having to review every listing to individually determine if they have previously seen a property. And if they have seen the property before, determine if any changes have occurred to the property.

Another novel feature of this invention is the show can be viewed on any device, including but not limited to, computers, smart phones, tablets, and televisions. Applications written for televisions, smart phones, tablets, or computers can be used to assist the user to view a show. A user can also view a show by broadcasting the show from their device, like a smart phone, tablet, or laptop, to a television using WiFi-based devices, such as Chromecast.

Date and time values used in this invention can also be based on date values only where the time value is set to a default value, such as midnight.

Other novel features are attained when this invention is viewed in its entirety.

### BRIEF DESCRIPTION OF THE DRAWINGS

FIG. 1 is a representative drawing of the main components of the invention.

FIG. 2 is a representative drawing showing a generated slide for a real estate listing used as part of a show.

### DETAILED DESCRIPTION OF THE INVENTION

The present invention provides a method and apparatus for users, such as buyers, renters, real estate agents, and brokers, the ability to view temporal-based presentations for residential and commercial properties using the Internet.

The present invention has been implemented. Selected parts of this implementation are detailed in this section.

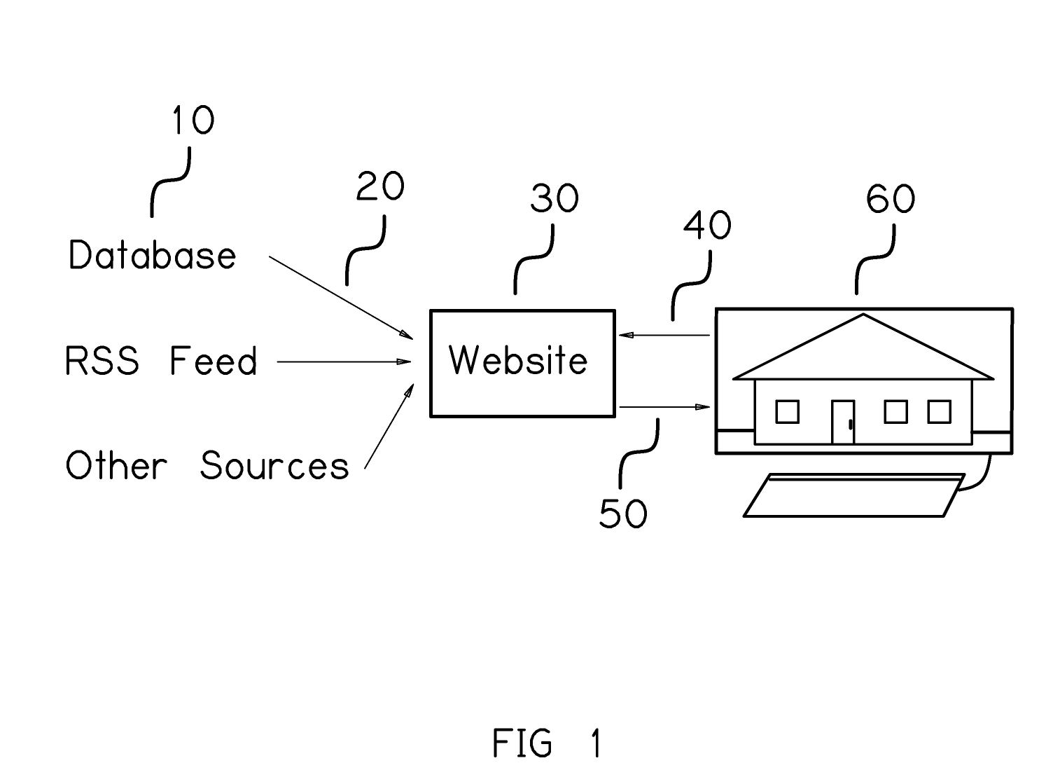

FIG. 1 shows the main components of the invention. The database, RSS feed, and other sources 10 provide data on real estate properties. The added date and time and/or last updated date and time 20 are either found in the data or can be determined by the website 30. When a user visits the website 30 from a device 60, such as a computer, the website 30 can determine the last visit date and time 40. The website 30 can then generate a temporal-based show 50 to display on device 60.

The show, also called a presentation, is based on the user's last visit date and time to website.

The last visit date and time is found in a cookie stored on the user's electronic device. Although not required, if the user logs into the website, the last visit date and time is read from the local database and is used instead.

In the following source code segment written in the PHP programming language, the source code checks to see if the visitor_epoch_time last visited cookie is set. If set, the last visit date and time is read from the user's device and the last_visit_found_flag is set to TRUE. If the last visit date and time is not set, the current date and time is used to set the last visit date and time which can be read the next time the user visits the website. Epoch time is a Unix timestamp representing the number of seconds that have elapsed since Jan. 1, 1970 (midnight UTC/GMT). Additional date and time variables in various formats are used in the implementation. The representative code segment follows:

$last_visit_found_flag = FALSE;
$t = getdate( );
$visitor_epoch_time_last_visited = $t[0];
if (isset($_COOKIE[‘visitor_epoch_time_last_visited’])) {

$last_visit_found_flag = TRUE;
$visitor_epoch_time_last_visited =
$_COOKIE[‘visitor_epoch_time_last_visited’];

}
setcookie(“visitor_epoch_time_last_visited”, “$t[0]”, time( )+7776000);

The date and time of when a property was added and was last updated can be stored in a local database used by the website. In our implementation, the listing table has two columns reserved for storing these date and time values, which are named date_added and date_last_modified. Identifying which properties were added or modified since the last visit date and time is done using a SELECT statement containing a WHERE clause.

In the RSS real estate feed, the ctime attribute contains the last change time for a listing. The ctime default value is the date and time when the listing was added to the feed. If the listing has been updated since it was added, ctime will contain the date and time when the listing was last modified. Identifying which properties were added or modified since the last visit date and time is done by comparing the ctime value for a listing with the last visit date and time value using an IF statement.

How the show is generated for the identified properties is not limited and can use any method of presentation.

In our current implementation, an introductory Joint Photographic Experts Group (JPG) slide is generated displaying the name of our business, date, and the number of added and updated properties to be shown in the show. Next a slide containing a city street map or a hybrid satellite map showing the locations of all added or updated properties can be displayed.

One or more overview slides are generated for each property and may contain the following property information when available:
1. the address, city, state, and zip code of property,
2. location displayed on a city street map,
3. location displayed on a hybrid satellite map,
4. short remark,
5. primary photo,
6. price,
7. number of bedrooms,
8. number of bathrooms,
9. square feet,
10. price per square feet,
11. lot size,
12. year built,
13. days on the market,
14. agent first and last name,
15. agent's office name,
16. agent's phone number,
17. additional photos,
18. slide number, and
19. indicators showing whether additional information, map, street view, and video are available.
   The above information is simply a representative example and is not intended to be a complete description of what information can be presented in any format on one or more JPG slides and in no way is restricted to only this information.

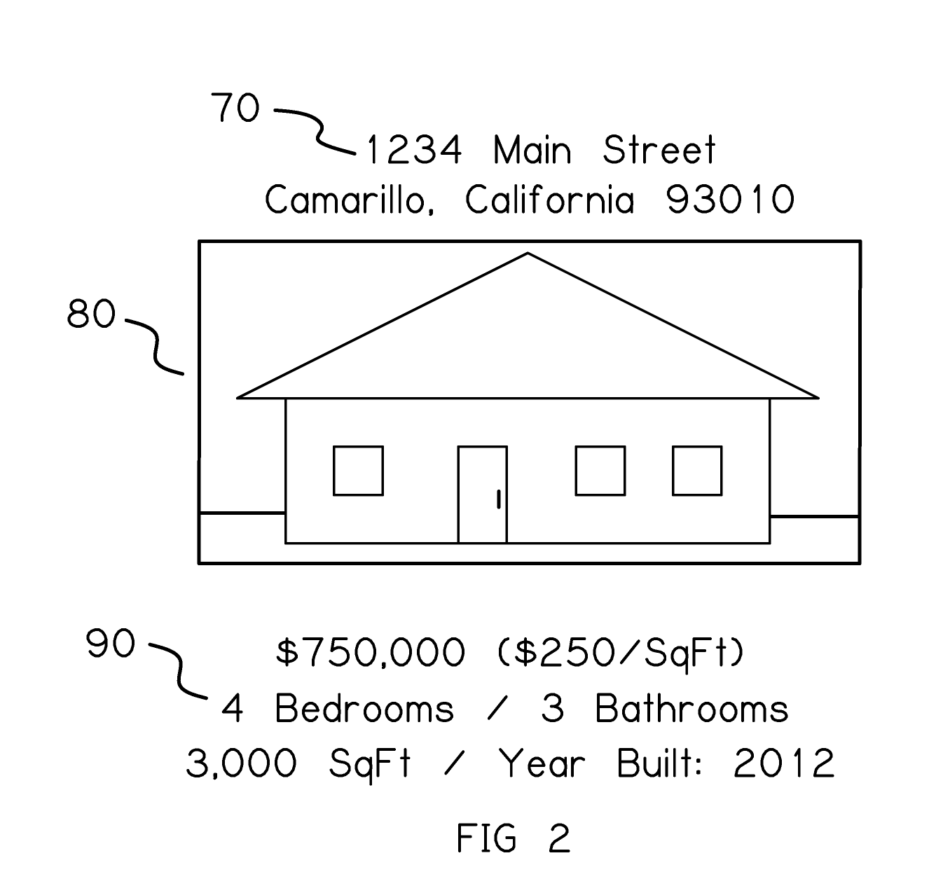

FIG. 2 shows one example on how property information can be used to generate a slide by displaying the address, city, state, and zip code 70, the primary photo 80, and additional property information 90, which includes the price, price per square feet, number of bedrooms, number of bathrooms, square feet, and year built.

Once each JPG slide is generated, each slide is added to three Advanced Stream Redirector (ASX) presentations in Windows Media Video (WMV), MPEG-4 Part 14 (MP4), and QuickTime™ File Format (MOV) formats. ASX files are one way to store a playlist of media files for a multimedia presentation. Which ASX file will be played depends on the device and software (e.g., web browser) the user uses to access the website. It should be noted that while ASX files are currently being used by our implementation, any and all other approaches can be used in presenting a multimedia show.

How long each slide is displayed is user configurable and is currently set to nine seconds before displaying the next property slide.

For each property which has video available, the video or interactive open house video tour's default path is played next in the ASX file. Slides prior to and after each video can be shown. For example, an introductory overview slide of property prior to the video being shown and agent contact slide after the video is shown is one of many options.

In other embodiments of this invention as the show is being played, the user can select links to display the listing page, map, street view, slide show, and video for property when available.

These novel temporal-based shows only display new and updated real estate listings specific to each user based on when they last visited a website. Contrast this with current websites where all listings are returned (over and over again) and it is up to the user to determine if they have already seen a listed property. And if they have already seen a property, users have to determine whether the listing has changed.

MLS can send emails and texts on regular periodic time intervals, usually on the hour, to inform agents of new and changed real estate properties. When agents check their emails, they have to open, review, and close each email. If the agent hasn't checked their email in a few days, they will need to review numerous emails. Compare this with our novel approach, which temporally presents real estate properties since the user's last visit date and time in a multimedia show that can be viewed on different devices.

Temporal-based presentations save users time by making it easy, easy as watching a customized TV show, to keep up-to-date with any newly added or recently updated properties for a local real estate marketplace.

But it should be noted there are many examples of using temporal-based multimedia shows outside of the real estate field too which include but are not limited to:
1. Anything for sale. For example, a user who wants to buy a used vehicle can take advantage of temporal-based shows to view overview slides, photos, and videos of used vehicles that have come onto the market since the user's last visit to a website.
2. Items for sale on an auction website where only newly added items are shown since the user's last visit to a website.
3. Job search websites where a user can view only recently added jobs since the user's last visit to a job website.
4. On demand movie websites where rather than seeing a section titled Recently Added Movies, where what qualifies as a “recently added movie” is determined by the movie website itself, users can instead see recently added movies and play the movie trailers as a show since their last visit.
5. Research websites where researchers who want to keep up with the latest publications can view only the new publications added to website since their last visit. Short overviews in any media format, e.g., slides or video, can be used to provide a brief overview on the conclusions of the research. If the user wants to learn more, links can be provided to display additional information.
6. Financial websites can play shows to highlight which companies have been added or company information updated since the user's last visit. Shows can incorporate overview slides, current target prices, and interviews with company executives.
   These are only some representative examples on how temporal-based shows can be used outside of the real estate field.

It should be understood that the method and apparatus for temporal-based real estate shows for real estate properties has been described above and in considerable detail but are merely illustrative applications of the overall principles of the present invention. Numerous modifications may be made by those skilled in the art without departing from the spirit and scope of the invention. Therefore, the spirit and scope of the appended claims should not be limited to the description of the preferred versions contained herein.

I claim:

1. A method of generating a temporal-based show based on the last visit date and time of user to a website, said method comprises:
associating an added date and time to real estate properties;
associating a last updated date and time to said real estate properties;
identifying said real estate properties whose said added date and time and said last updated date and time are more recent than or equal to said last visit date and time of said user to said website;
generating a said temporal-based show containing only said identified said real estate properties; and,
presenting said temporal-based show to said user.

2. The method of claim 1, wherein said temporal-based show displays a location of said identified said real estate properties on a city street map.

3. The method of claim 1, wherein said temporal-based show displays a location of said identified said real estate properties on a hybrid satellite map.

4. The method of claim 1, wherein said temporal-based show displays said identified said real estate properties in a multimedia presentation.

5. A method of generating a temporal-based show based on a time frame value specified by the user to a website, said method comprises:
associating an added date and time to real estate properties;
associating a last updated date and time to said real estate properties;
identifying said real estate properties whose said added date and time and said last updated date and time are more recent than or equal to said time frame value of said user to said website;
generating a said temporal-based show containing only said identified said real estate properties; and,
presenting said temporal-based show to said user.

6. The method of claim 5, wherein said temporal-based show displays a location of said identified said real estate properties on a city street map.

7. The method of claim 5, wherein said temporal-based show displays a location of said identified said real estate properties on a hybrid satellite map.

8. The method of claim 5, wherein said temporal-based show displays said identified said real estate properties in a multimedia presentation.
